(19) United States
(12) Patent Application Publication
(10) Pub. No.: US 2024/0159465 A1
(43) Pub. Date: May 16, 2024

(54) HOT WALL BELL-TYPE FURNACES AND ASSOCIATED METHODS

(71) Applicant: IperionX Limited, Charlotte, NC (US)

(72) Inventors: Thomas Wingens, Charlotte, NC (US); Hyrum Lefler, Charlotte, NC (US)

(21) Appl. No.: 18/511,915

(22) Filed: Nov. 16, 2023

Related U.S. Application Data
(60) Provisional application No. 63/425,951, filed on Nov. 16, 2022.
(60) Provisional application No. 63/489,978, filed on Mar. 13, 2023.

(51) Int. Cl. F27B 5/04; F27B 5/16; F27D 7/00

(52) U.S. Cl. CPC F27B 5/04; F27B 5/16; F27D 7/00; F27D 2007/066

(57) ABSTRACT

Hot wall bell-type furnaces and methods of treating metal and/or ceramic articles. A method of treating a metal/ceramic article includes placing the article with a tray/fixture on a furnace hearth. A retort bell can be placed over the fixture with the article. A furnace bell is then placed over the retort bell. A retort pressure in the retort bell can be reduced to a first vacuum pressure, and a support pressure in a plenum space between the retort bell and the furnace bell can be reduced to a second vacuum pressure. The article can be heated to a treatment temperature which can be maintained along with the first vacuum pressure and second vacuum pressure to treat the article to form a treated article. The article can be one or more of a green body to be sintered, a sintered article, and a cast article to be treated by any suitable heat treatment.

### RELATED APPLICATIONS

This application claims priority to U.S. Provisional Application No. 63/425,951, filed Nov. 16, 2022 and U.S. Provisional Application No. 63/489,978, filed Mar. 13, 2023, which are each incorporated herein by reference.

### BACKGROUND

Powder metallurgy (PM) involves fabricating metal articles by sintering metal powders. In many processes, a metal powder is used to form a green body. Various methods can be used to form the green body, including molding, pressing, 3D printing, and others. In some cases, the green body can include a binder that can bind metal particles together. Depending on the type of binder used, the binder may be removed prior to or during the sintering process. Processes have been developed for debinding and sintering green bodies. Some of these processes utilize cold wall vacuum furnaces. These furnaces can be capable of heating the green body to high sintering temperatures and maintaining vacuum pressures, but cold wall vacuum furnaces often require expensive maintenance and can have poor temperature uniformity when operating at partial pressures. Cold wall furnaces can be expensive to operate due to cooling of furnace walls while simultaneously heating the adjacent sintering zone. When organic binders are used in the green body, organic residues can be deposited in cold spots in the cold wall furnace, and these residues can cause contamination of sintered materials. Hot wall furnaces have also been used. However, hot wall furnaces are often limited in the sintering temperature that can be reached and typically operate under atmospheric pressures.

### SUMMARY

The present disclosure describes hot wall bell-type furnaces and methods of treating metal and/or ceramic articles using the furnaces. In one example, a method of treating a metal/ceramic article includes placing a metal/ceramic article with a tray/fixture on a furnace hearth. A retort bell can be placed over the load with the metal/ceramic article(s). A furnace bell is then placed over the retort bell. A retort pressure in the retort bell can be reduced to a first vacuum pressure, and a support pressure in a plenum space between the retort bell and the furnace bell can be reduced to a second vacuum pressure. The metal/ceramic article can be heated to a treatment temperature. The treatment temperature can be maintained along with the first vacuum pressure and second vacuum pressure to treat the metal/ceramic article to form a treated metal/ceramic article. The metal/ceramic article can be a green body to be sintered, or can be a sintered or cast article to be treated by any suitable heat treatment such as, but not limited to, hydrogen heat treatment, hydriding, dehydriding, deoxygenation, and the like.

The present disclosure also describes hot wall furnaces. In one example, a furnace includes a base station including a metal/ceramic article support and a vacuum source. A retort bell is sealable onto the base station over the metal/ceramic article support to form a retort space. The retort bell can be adapted to a treatment temperature e.g. 1,000° C. A furnace bell is sealable onto the base station over the retort bell such that the retort bell is contained within a volume between the base station and the furnace bell to form a plenum space. The vacuum source can be adapted to maintain a vacuum pressure in the retort space and in the plenum space.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a flow chart illustrating an example method of treating a metal/ceramic article in accordance with the present disclosure.

FIG. 2 is a cross-sectional side view of an example hot wall furnace in accordance with the present disclosure.

FIG. 3 is a cross-sectional side view of another example hot wall furnace in accordance with the present disclosure.

FIG. 4 is a cross-sectional top-down view of another example hot wall furnace in accordance with the present disclosure.

FIG. 5 is a schematic view showing a gantry for moving the retort and furnace bells in accordance with another example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

As used herein, “vacuum pressure” refers to any pressure that is less than ambient pressure, such as less than about 1 atmosphere.

As used herein, “green body” refers to an object made of sinterable material that is in an unsintered state. These can include powders of metal, metalloids, carbon, and the like. In some cases, a green body will also include a binder which helps metal/metalloid powder to adhere together during processing up to sintering.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The use of the terms “a” and “an” and “the” and similar referents in the context of describing the elements (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Additionally, the phrase “consisting essentially of” will be understood to include those elements specifically recited and those additional elements that do not materially affect the basic and novel characteristics of the claimed invention. The phrase “consisting of” excludes any element not specifically specified.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Hot Wall Furnaces and Methods

The present disclosure describes hot wall furnaces that can be used at higher temperatures, with less maintenance, lower energy consumption, and less contamination of metal/ceramic materials compared to furnace designs currently in use for such processes. These hot wall furnaces are also highly scalable in design due at least partially to the use of a double wall as described. The hot wall furnaces described herein can include a double wall made up of a retort bell and a furnace bell. The retort bell can be placed over a metal/ceramic article to be heat treated, e.g. a green body that is to be sintered, a metal/ceramic article to be hydrided/dehydrided, etc. The furnace bell can then be placed over the retort bell. The furnace bell can be larger than the retort bell so that a plenum space is formed between the outer surface of the retort bell and the inner surface of the furnace bell. Both the retort bell and the furnace bell can be sealed against a base station, typically with the bases station positioned under the retort bell and furnace bell. Thus, a sealed retort space is formed inside the retort bell and a sealed plenum space is formed between the retort bell and the furnace bell. The pressure can be reduced in both the retort space and in the plenum space. The pressure in the retort space can be reduced to a first vacuum pressure, and the pressure in the plenum space can be reduced to a second vacuum pressure. In some cases, the first vacuum pressure and the second vacuum pressure can be close or equal one to another, such as within about 10% of each other. When the pressures are close or equal in this way, the net force of pressure on the retort bell can be reduced or eliminated. In prior hot wall vacuum furnaces, pressure is often a significant driving force behind leakage of air or other contaminants into the furnace. In the furnaces described herein, this force is greatly reduced or eliminated. Therefore, the amount of air and other contaminants that may leak into the retort bell can be greatly reduced. This tends to reduce residue within the furnace and accompanying cleaning costs between furnace cycles. The retort bell can contain a lower concentration (i.e., parts per million) of oxygen at high vacuum levels compared to prior hot wall furnaces at the same vacuum levels.

The furnaces described herein can be capable of treating metal/ceramic articles at high temperatures, such as above 1,000° C. or even above 1,250° C. in some cases, and at low pressures, such as down to about 10⁻⁶ millibar in some examples. Many prior hot wall furnace designs may not be capable of achieving such high treatment temperatures and such low vacuum pressures while treating materials with low contaminant levels. In some cases, the treatment can be a sintering process which can optionally include debinding or hydrogen sintering with phase transformation. Alternatively, the treatment can include heat treatment of a sintered article through hydrogen heat treatments, hydriding, dehydriding, deoxygenation, hydrogen heat treatment, or the like.

In the furnaces described herein, the hot wall can refer to the retort bell that surrounds the metal/ceramic article. In some examples, the retort bell can be heated by the furnace bell. For example, the furnace bell can include heating elements on the interior of the furnace bell and the heating elements can heat the retort bell. This can cause the retort space inside the retort bell to be heated along with the green body inside the retort bell. The temperature inside the retort bell can be highly uniform in some examples. For example, a temperature variation between the coldest location inside the retort bell and the hottest location inside the retort bell can be about 50° C. or less, 10° C. or less, or about 5° C. or less, or about 1° C. or less. In further examples, the furnace bell can be designed without active cooling equipment such as a water jacket or other cooling features. However, in some examples the furnace bell can include insulation material and the insulation material can at least partially insulate the furnace bell from the retort bell. Therefore, the outer surface of the furnace bell can often be colder than the retort bell. In some examples, the outer surface of the furnace bell can be air cooled by ambient air.

Some prior cold wall furnaces may have low temperature uniformity inside the furnace. This can lead to deposition of binder residue in cold spots in the furnace. The residue can then contaminate subsequent batches of metal/ceramic article materials. Cold wall furnaces also often have high thermal stresses due to the large temperature differences and high corrosion rates. These can lead to expensive maintenance and replacement of equipment. As explained above, the furnaces described herein can have good temperature uniformity, which can reduce or eliminate the build up of binder residues inside the retort bell of the furnace during sintering processes. The retort bell can also have a vertical cylindrical shape, which can be free to expand and contract with temperature changes. Therefore, the thermal stresses experienced by the retort bell can be lower. The retort bell is also not subject to fast corrosion since the retort bell is surrounded by vacuum pressures on both sides during sintering, and thus little or no corrosive agents contact the retort bell during heat treatments.

Some prior hot wall and cold wall furnaces have utilized expensive materials such as molybdenum and tungsten. These materials have been used to construct retort zones and heating elements in some furnaces. However, these elements are costly and typically are replaced after a few years. However, the furnaces described herein can be made without molybdenum or tungsten. Materials that can be used to construct the retort bell can include stainless steel, silicon carbide, carbon fiber, Inconel, quartz, graphite, composites thereof, alloys thereof, or a combination thereof. In some examples, the retort bell can be made of stainless steel and the furnace can be used at treatment temperatures such as sintering temperatures up to about 1,200° C. or even 1,250° C. In further examples, other materials can be used at even higher temperatures. For example, silicon carbide can be used at treatment temperatures up to about 1,450° C. Therefore, the maximum treatment temperature can depend on the material of the retort bell. The furnace bell can be constructed of even cheaper materials, such as carbon steel. The heating elements in the furnace bell can be any type of heating elements, such as steel heating elements. Any contamination that might otherwise be caused by the heating elements and furnace bell materials can be reduced because of the vacuum pressure employed in the plenum space, which can be equal or close to the vacuum pressure in the retort bell.

The furnaces described herein can also be operated more economically compared to prior furnaces. As explained above, the furnaces described herein can have lower costs of maintenance and replacement of equipment compared to some prior cold wall and hot wall furnaces. The upfront cost of the furnaces can also be lower because of the use of cheaper materials. The furnaces described herein can also have lower energy demands compared to prior cold wall and hot wall furnaces. Cold wall furnaces consume a large amount of power to simultaneously heat the material being sintered or subjected to other heat treatments while also cooling the walls of the furnace. The furnaces described herein can save this power usage by heating the retort bell without cooling the retort bell or the furnace bell. Such energy savings also result in a reduced carbon footprint.

In some examples, the retort bell can be cooled after the heat treatment is complete, before the treated metal/ceramic article is unloaded from the retort bell. However, this one-time-cooling can consume less energy than constantly cooling the walls as in a cold wall furnace. Additionally, the furnace bell can be lifted off the retort bell before the retort bells is cooled. The furnace bell may be kept hot without cooling the furnace bell between batches. This can also save the power that might otherwise be used to cool and reheated the furnace bell for each batch. In some systems, the furnace bell can be removed from a first retort bell and then moved to a second retort bell to perform another heat treatment operation while the first retort bell is being cooled and unloaded.

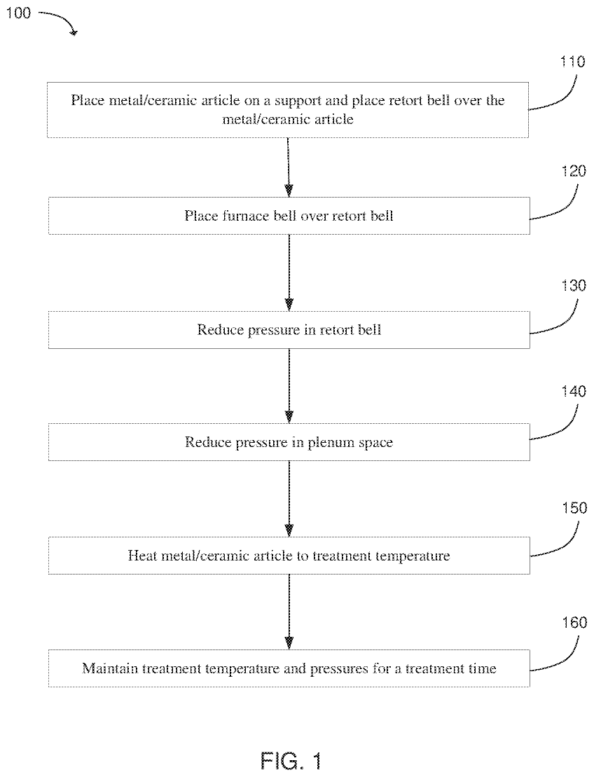

In one aspect, the present disclosure describes methods of treating metal/ceramic articles. One example method 100 of treating a metal/ceramic article is illustrated in FIG. 1. The method includes: placing a metal/ceramic article in a retort bell 110; placing a furnace bell over the retort bell 120; reducing a retort pressure in the retort bell to a first vacuum pressure 130; reducing a support pressure in a plenum space between the retort bell and the furnace bell to a second vacuum pressure 140; heating the metal/ceramic article to a treatment temperature 150; and maintaining the treatment temperature, first vacuum pressure, and second vacuum pressure for a treatment time to form a treated metal/ceramic article 160.

In one example method, where the metal/ceramic article is a green body the method utilizes a sintering temperature and vacuum pressure to sinter the green body. The sintering temperature can be any temperature at which the green body object can become sintered. Sintering can be possible at a range of temperatures for any given material, and different materials can be sintered at different ranges of temperatures. Therefore, the sintering temperature that is utilized can be any temperature within the range appropriate for the specific green body material. It is noted that “maintaining the sintering temperature” means that the temperature of the green body remains within the range of temperatures that is appropriate for sintering that particular green body material during the sintering time period. The temperature of the green body can fluctuate and change within this range during the sintering time, in some examples. Thus, the methods described herein are not limited to holding the temperature of the green body at a single, unchanging temperature throughout the entire sintering time. Rather, the green body temperature can be maintained within the range of sintering temperatures during the sintering time.

The metal/ceramic article can be a metal, metal alloy, ceramic, or composite thereof. Non-limiting examples of suitable metals can include Ti, Fe, Al, Zr, Cu, Zn, Au, Ag, Pd, Zn, Sn, Pb, V, Ni, Cr, Mn, Co, Nd, Nb, Mo, W, Ta, alloys thereof, and the like. Non-limiting examples of ceramics can include carbides (e.g. SiC, WC, B₄C, etc), nitrides (e.g. Si₃N₄, AlN, BN, etc), silicides (e.g. MoSi₂, WSi₂, etc), borides (e.g. TiB₂, ZrB₂, HfB₂, etc), Sialons (e.g. Si—Al—O—N), and carbide/boride composites (e.g. TiB₂—C, etc).

The first and second vacuum pressures can be any pressure below the ambient atmospheric pressure. The method can also include maintaining a first and second vacuum pressure in the retort bell and the plenum space during the sintering time. Maintaining the first and second vacuum pressures can also include fluctuations and changes in these pressures during the sintering time, so long as the pressures are vacuum pressures, i.e., below the ambient atmospheric pressure.

Further, the methods as outlined above with respect to sintering can include debinding and sintering as described, as well as other sintering processes, heat treatment, phase transformation and similar processes such as hydrogen sintering and phase transformation (HSPT). For example, in the case of HSPT, a hydrogen atmosphere is maintained during sintering and the sintered product can be held at a phase transformation temperature to adjust a microstructure of the sintered product (e.g. including eutectoid decomposition to refine grain sizes). Hydrogen partial pressures can be adjusted during the process to obtained a designed balance of phase transformations between metallurgical phases for a given metal, metal alloy, ceramic, or composite thereof. The sintered and optionally treated product can be dehydrogenated. HSPT processing is more thoroughly described in U.S. Pat. Nos. 10,190,191; 10,689,730; and 10,907,239 which are incorporated herein by reference. Other heat treatment processes can also be used such as, but not limited to, hydrogen heat treatments (e.g. U.S. Pat. No. 11,624,105 which is incorporated herein by reference), hydriding and dehydriding processing, deoxygenation, and the like. In these cases, the metal/ceramic article can be a sintered article, a cast article, or a machined article. For example, hydriding can include heating the metal/ceramic article to a hydrogenation temperature under a hydrogen-containing atmosphere sufficient to allow hydrogenation of at least a portion of the metal/ceramic within the metal/ceramic article. Dehydriding can include heating the metal/ceramic article to a dehydrogenation temperature under a hydrogen-deficient atmosphere to allow hydrogen to be removed at least partially or fully from the metal/ceramic article. Deoxygenation can include heating the metal/ceramic article to a deoxygenation temperature under an oxygen deficient environment sufficient to allow oxygen to diffuse out of the metal/ceramic article in the case of dissolved oxygen. In the case of metal oxides, a deoxygenation agent can be included depending on the specific metal. Non-limiting example of deoxygenation agents can include Mg, Ca, and the like. Specific treatment temperatures and times for these processes can depend largely on the particular composition of metal, ceramic, metal alloys, porosity, and other factors.

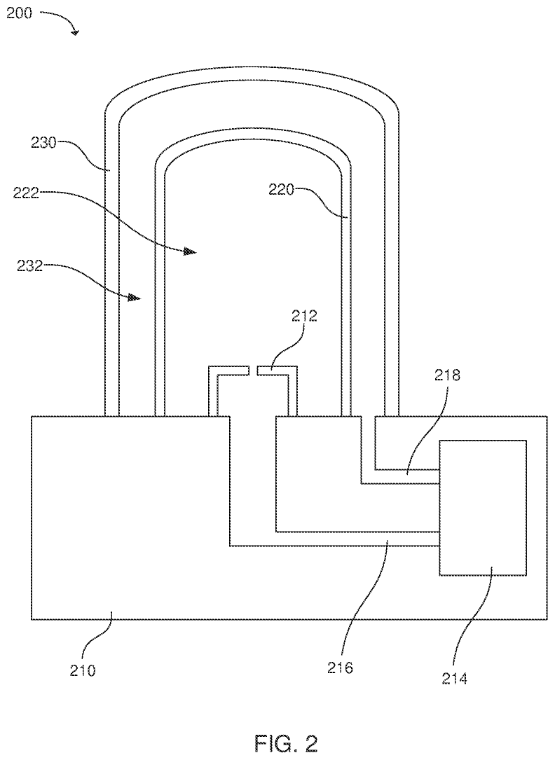

Another aspect of the present disclosure can include hot wall furnaces. The furnaces can be used to perform the methods of treating metal/ceramic articles described herein. One example hot wall furnace 200 is shown in FIG. 2. This example includes a base station 210 that includes a metal/ceramic article support 212 and a vacuum source 214. A retort bell 220 is sealable onto the base station over the metal/ceramic article support. Thus, the retort bell can be placed over the metal/ceramic article support and a metal/ceramic article held by the support. The space inside the retort bell can be referred to as a retort space 222. The retort bell can act as a hot wall bell. Accordingly, the retort bell can be made from materials suitable for treatment temperatures such as temperature above 1,000° C. A furnace bell 230 can also be sealed onto the base station over the retort bell. The space between the furnace bell and the retort bell can be referred to as a plenum space 232. The vacuum source can be adapted to maintain a vacuum pressure in the retort space and in the plenum space. In this example, the vacuum source is connected to the retort space by a retort vacuum line 216 and to the plenum space by a plenum vacuum line 218.

In some examples, the retort bell can be adapted to a treatment temperature above 1,000° C., or above 1,100° C., or above 1,200° C., or above 1,250° C., or above 1,300° C., or above 1,400° C., or ranges such as 800-900° C., 850-950° C., 900-1000° C., 950-1050° C., 1000-1100° C., or 1150-1450° C. As used herein, “adapted to a treatment temperature” means that the retort bell can be effectively used and re-used multiple times to heat treat a metal/ceramic article such as sintering green body objects at that sintering temperature. The retort bell can be made of a material that retains its structural integrity at the treatment temperature. Therefore, the material does not melt, soften, break apart, or otherwise structurally fail at the treatment temperature. Additionally, the retort bell can be made of a material that does not introduce contaminants to the metal/ceramic article when heated to the treatment temperature. It is noted that in some cases the retort bell may break down or wear out over time due to the stresses of being heated and cooled. However, a retort bell that is adapted to the treatment temperature can be used for multiple treatment runs before replacement. In some examples, the retort bell can be capable of being used for at least 10 treatment runs, or at least 50 treatment runs, or at least 100 treatment runs, or at least 200 treatment runs, or at least 1,000 treatment runs before replacement.

The retort bell and the furnace bell can have a cylindrical shape, which can help allow the retort bell and furnace bell to be used for more treatment runs without replacement because the cylindrical shape can have lower thermal stress when heated compared to other shapes. In some examples, the cylindrical bells can have a domed top or a flat top. The retort bell and furnace bell size can vary depending on the size of materials that are to be heat treated. In some examples, the retort bell can have an outer diameter from about 20 cm to about 10 m, or from about 20 cm to about 5 m, or from about 20 cm to about 3 m, or from about 20 cm to about 2 m, or from about 20 cm to about 1 m, or from about 50 cm to about 2 m, or from about 1 m to about 3 m, or from about 1 m to about 5 m. The retort bell can have metal walls with a thickness from about 2 mm to about 5 cm, or from about 2 mm to about 2 cm, or from about 2 mm to about 1 cm, in some examples. The furnace bell can be sized larger than the retort bell so that the retort bell fits inside the furnace bell. In some examples, the furnace bell can have an outer diameter from about 30 cm to about 12 m, or from about 30 cm to about 6 m, or from about 30 cm to about 4 m, or from about 30 cm to about 2 m, or from about 80 cm to about 4 m, or from about 1.5 m to about 4 m.

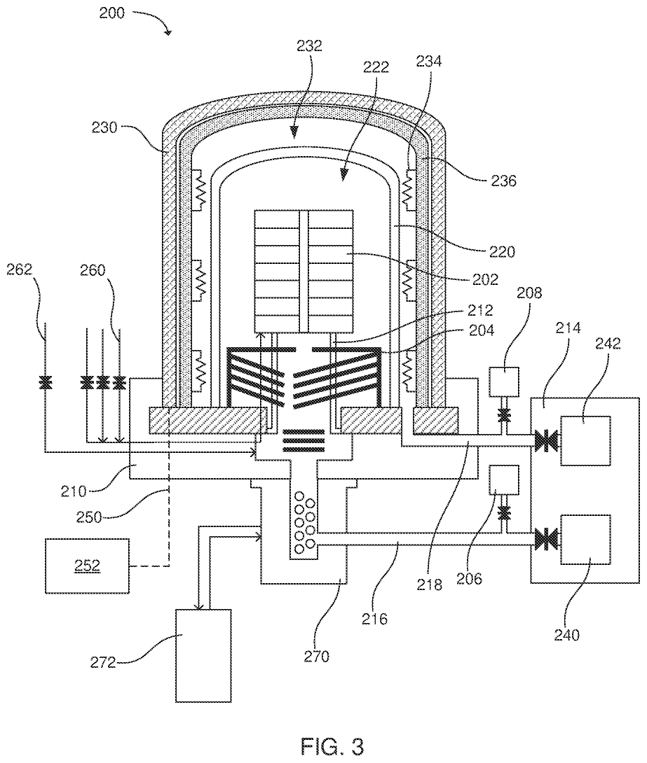

Another example hot wall furnace 200 is shown in FIG. 3. This furnace includes a base station 210 that provides a floor surface onto which a retort bell 220 and a furnace bell 230 are sealed. The retort bell is the smaller inner bell. A metal/ceramic article to be treated is placed on a metal/ceramic article support 212 inside the retort bell. In this example, the metal/ceramic article support is a hearth support that holds a stack of trays 202 above a baffle system 204. The trays are positioned in an upper portion of the retort space 222 inside the retort bell. The baffles are positioned in a lower portion of the retort space. The trays in this example are ring-shaped trays. The ring-shaped trays include a central opening in the center of the rings, and this central open space allows gases to flow from the trays down to the bottom of the retort bell where the gases can be removed by the vacuum pump. The trays can be used to hold multiple metal/ceramic articles to be heat treated. In some examples, the furnaces described herein can be used to sinter granulated metal/ceramic powder, made up of granules that each individually contain many smaller metal/ceramic particles bound together by a binder. After being sintered, the granules can be useful as a 3D printing build material, among other applications. Thus, the trays can be filled with metal/ceramic granules to be sintered in some examples.

As shown in FIG. 3, the furnace bell 230 seals onto the base station 210 such that the retort bell 220 is surrounded by the furnace bell. The space between the retort bell and the furnace bell is referred to as the plenum space 232. The plenum space and the retort space 222 can be fluidly separate one from another, meaning that there is no pathway for fluid to flow from the plenum space into the retort space or vice versa. Some small amount of leakage may occur at the seal between the retort bell and the base station. However, as explained above, the pressures in the plenum space and the retort space can be maintained close or equal one to another. Therefore, the pressure driving force that may cause such leakage can be very small. In the example shown in FIG. 3, the base station includes a first vacuum pump 240 connected to the retort space by a first vacuum line 216 and a second vacuum pump 242 connected to the plenum space by a second vacuum line 218. In this example, the vacuum source 214 includes both the first vacuum pump and the second vacuum pump. These vacuum pumps can be used to reduce the pressure in the retort space and the plenum space to a vacuum pressure. In other examples, a single vacuum pump may be connected to both the retort space and the plenum space. However, using two vacuum pumps can allow the plenum space and retort space to be fluidically separated and can allow for independent control of the pressures in the plenum space and retort space. The example shown in FIG. 3 also includes a first pressure gauge 206 connected to the first vacuum line and a second pressure gauge 208 connected to the second vacuum line.

In some examples, the pressure in the retort space can be reduced to a first vacuum pressure from about 10⁻⁶ millibar to 500 millibar, and the pressure in the plenum space can be reduced to a second vacuum pressure from 10⁻⁶ millibar to 500 millibar. In other examples, the first and second vacuum pressures can be from about 10⁻⁵ millibar to about 5 millibar, or from about 10⁻⁵ millibar to about 1 millibar, or from about 10⁻⁵ millibar to about 10⁻² millibar. In certain examples, the first vacuum pressure can be within about 10% of the second vacuum pressure. In other words, the first vacuum pressure can be from 90% of the second vacuum pressure to 110% of the second vacuum pressure, on an absolute pressure basis. In further examples, the first vacuum pressure can be within about 5% of the second vacuum pressure, or within about 1% of the second vacuum pressure, or within about 0.1% of the second vacuum pressure. In some cases, the first vacuum pressure can be within 35% of the second vacuum pressure.

The furnace bell 230 can include heating elements 234, as shown in FIG. 3. The heating elements can be positioned inwardly in the furnace bell toward the retort bell 220. elements can be powered through a power connector 250 in the base station. The power connector can connect the heating elements to a power source 252 such as grid electricity, a generator, a battery, or other power source. The heating elements can heat the retort bell, and this can in turn heat the metal/ceramic article inside the retort bell. Because the heating elements are positioned in the plenum space, and not inside the retort bell, the metal/ceramic article being heat treated is not directly exposed to the heating elements. Therefore, the heating elements can be made from materials that may give off contaminants that would contaminate the metal/ceramic article if they were in the same space. In this example furnace, any contaminants that originate from the heating elements can be pumped out of the plenum space by the second vacuum pump 242 without ever contacting the metal/ceramic article. In some examples, the heating elements can include materials such as iron, carbon steel, Fe—Cr—Al alloy, Ni—Cr—Fe alloy, and others.

In the example shown in FIG. 3, the furnace bell 230 also includes insulation layer 236 between the heating elements 234 and the shell of the furnace bell. This insulating material can at least partially insulate the shell of the furnace bell, keeping the outer surface of the furnace bell at a cooler temperature than the retort bell 220. The insulating material can be adapted to high treatment temperatures, such as greater than 1,000° C., or greater than 1,200° C., or greater than 1,250° C., or greater than 1,400° C. in some examples. Insulation materials can include mica, ceramic fiber, fire bricks, microporous silica, carbon fiber, and other insulation materials. In some examples, the insulation can be formed as a layer on the interior surface of the furnace bell. The layer can have a thickness from about 1 cm to about 50 cm, or from about 1 cm to about 20 cm, or from about 1 cm to about 15 cm, or from about 1 cm to about 10 cm, in some examples.

In some examples, the green body can be heated to a sintering temperature from about 600° C. to about 1,250° C. In other examples, the sintering temperature can be from about 600° C. to about 700° C., or from about 700° C. to about 800° C., or from about 800° C. to about 1,000° C., or from about 1,000° C. to about 1,250° C., or from about 800° C. to about 1,250° C., or from about 600° C. to about 1,000° C., or from about 1,100° C. to about 1,250° C., or from about 1,200° C. to about 1,250° C. The green body can be held at the sintering temperature for a sintering time sufficient to sinter the green body, depending on the materials, desired densification, etc. As a non-limiting example, suitable sintering times may be 5 minutes to one hour. In further examples, the sintering time can be from 5 minutes to 5 hours, or from 5 minutes to 3 hours, or from 5 minutes to 2 hours, or from 10 minutes to 1 hour, or from 20 minutes to 1 hour, or from 30 minutes to one hour, or from 5 minutes to 30 minutes.

The retort bell can be heated to a very uniform temperature throughout the various parts of the retort bell. The volume inside the retort bell can also be at a uniform temperature. Therefore, the metal/ceramic article can have a uniform temperature during heat treatment. After the retort bell has been heated up to a steady state treatment temperature, the temperature variation in the retort volume can be low. For example, a coldest location inside the retort bell and a hottest location inside the retort bell can be within 100° C. of one another, or within 50° C. of one another, or within 20° C. of one another, or within 10° C. of one another.

It is noted that treatment processes such as sintering processes and others can include a variety of thermal processing steps, such as heating and cooling the material at multiple different temperatures. Such steps can be used for various purposes such as to effect phase transformations, deoxygenation, refining grain structure, etc. As used herein, “maintaining the treatment temperature for a treatment time” can encompass all these operations or any thermal operations at which the desired treatment such as sintering, hydriding, dehydriding, phase transformations, deoxygenation, etc. occurs. Additionally, it may be desired to change the pressure or composition of the atmosphere at various times during the treatment process for a variety of purposes. As used herein, “maintaining the first vacuum pressure and second vacuum pressure for a treatment time” can refer to maintaining any pressure less than ambient pressure while treatment is occurring, although in some cases the pressure may be changed and the composition of the atmosphere may be changed at some point during the treatment process. Accordingly, “maintaining the treatment temperature, first vacuum pressure, and second vacuum pressure for a treatment time” is not to be construed as limiting the treatment process to rigidly remaining at a single temperature and pressure for the entire time that treatment is occurring.

In this case of sintering, the sintering time and sintering temperature can be sufficient to sinter the green body to a desired level of densification. In some examples, the sintered article (when sintering is complete) can have a densification from about 85% to about 99.9%, or from about 90% to about 95%, or from about 95% to about 99.9%, or from about 93% to about 97%, or from about 97% to about 99.9%, or from about 93% to about 99%, or from about 93% to about 97%.

The furnace shown in FIG. 3 also includes process gas inlets 260 that can be used to introduce noble gases, non-reactive gases, or a combination thereof into the retort space 222. In some examples, a noble or non-reactive gas such as argon, helium, nitrogen, other gas, or mixture of such gases can be introduced at a low pressure into the retort bell 220 and/or furnace bell 230 during sintering. The noble gas can be supplied at a pressure of about 10⁻¹ millibar to about 10⁻³ millibar, or about 10⁻² millibar to about 10⁻³ millibar, or about 10⁻¹ millibar to about 10⁻² millibar in some examples. The furnace also includes a backfill inlet 262 that can be used to backfill air into the retort bell and furnace bells before the bells are unsealed and lifted off the base station 210.

It is noted that although the example shown in FIG. 3 shows the vacuum pumps, power connector, and noble gas source as parts of the base station, in other examples these may be separate components. In some examples, the vacuum pumps, power connector, and/or noble gas source can connect to the furnace bell and retort bell in other ways such as through connectors on the furnace bell and retort bell themselves. However, in some examples it can be useful for these components to connect through the base station to the bottom openings of the retort bell and furnace bell because then the retort bell and furnace bell can have a simpler design with fewer openings that might allow leaks.

The furnace shown in FIG. 3 also includes a cold trap 270 in the base station positioned under the retort bell. The first vacuum pump 240 pumps gas out of the retort bell 220 and the gas passes through the cold trap as it is pumped toward the vacuum pump. The cold trap can condense any condensable species such as organic compounds that evolve from an organic binder in a green body. The cold trap can be oriented in a location at an edge of or adjacent to the retort space. Temperatures at the cold trap can be lower than temperatures in the retort space. The lower temperature in the cold trap can be sufficient to condense at least a portion of vaporized binder from the green body. In this example, the cold trap is connected to a cooling system 272 that cools the cold trap. The cooling system can include an air cooled heat sink, a water cooled heat sink, an evaporative cooler, a refrigeration system, or another type of system for cooling the cold trap. In some examples, the cold trap can include a water jacket and water can be circulated between the cold trap and the cooling system to cool the cold trap. The temperature of the cold trap can be below the temperature in the retort bell. In some examples, the temperature in the cold trap during sintering can be from about 20° C. to about 500° C., or from about 50° C. to about 300° C., or from about 50° C. to about 200° C., or from about 50° C. to about 100° C.

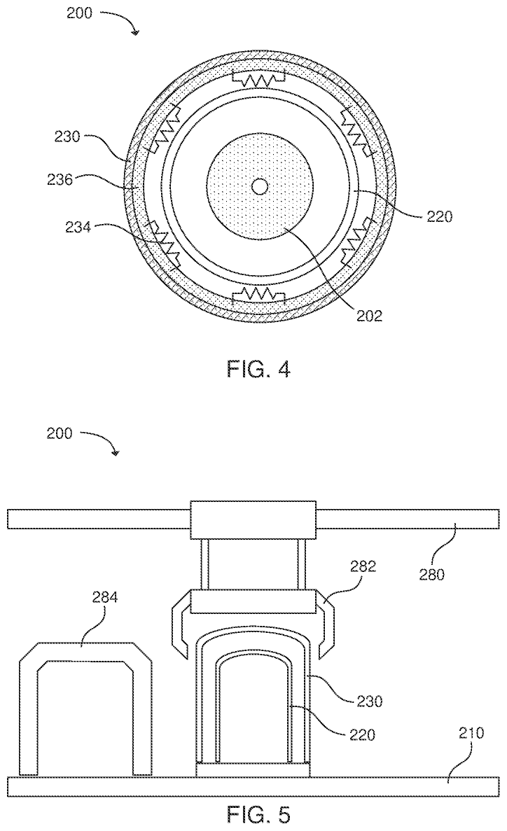

FIG. 4 shows a top-down cross-sectional view of an example hot wall furnace 200. The outer circle is the furnace bell 230. An insulation layer 236 and heating elements 234 are on the interior surface of the furnace bell. A retort bell 220 is positioned inside the furnace bell. A ring-shaped tray 202 for holding metal/ceramic articles is inside the retort bell. The heating elements are positioned to radiated heat inward toward the retort bell. Thus, the retort bell is uniformly heated from all sides. The base station and other components are not shown in this figure.

FIG. 5 shows another example hot wall furnace 200. This example includes a base station 210 with a retort bell 220 and a furnace bell 230 on the base station as in the previous example. This example also includes a gantry 280 with a crane 282 that can be used to lift the bells off of the base station. A cooling shroud 284 is also shown next to the furnace bell and retort bell. After a metal/ceramic article has been treated, the gantry can be used to remove the furnace bell from the retort bell. The gantry can then lift the cooling shroud and lower the cooling shroud onto the retort bell. The cooling shroud can force cool the retort bell quickly using cold air, water, or other cooling mechanisms. In some cases, the furnace bell can simultaneously act as a cooling shroud. In either case, a cooling mechanism can be adapted to cool the retort bell and corresponding metal/ceramic materials by removing heat. For example, a cooling fluid can be circulated through or adjacent to the cooling shroud. Alternatively, a thermoelectric cooler can be attached to or be oriented adjacent to the cooling shroud.

In addition to sintering green body objects as described above, the hot wall furnaces can also be used to debind the green body objects. In some examples, the green body can be made up of metal/ceramic particles bound together with an organic binder. The green body can be heated inside the metallurgical furnace to a debinding temperature before sintering. At the debinding temperature, the binder can volatilize, chemically decompose, or a combination thereof such that the organic binder material leaves the green body. As explained above, in some examples the organic material can be condensed in a cold trap that is connected to the vacuum line that draws gas out of the retort bell. The debinding temperature can be various temperatures depending on the type of binder used. In some examples, the debinding temperature can be from about 150° C. to about 500° C., or from about 150° C. to about 300° C., or from about 150° C. to about 200° C., or from about 200° C. to about 500° C., or from about 300° C. to about 500° C. The debinding time can be from about 5 minutes to about 5 hours, or from about 5 minutes to about 3 hours, or from about 5 minute to about 2 hours, or from about 5 minutes to about 1 hour, or from about 5 minutes to about 30 minutes, in some examples. Non-limiting examples of binders that can be used include paraffin wax, PVA, PEG, PVB, PVP, PMMA, micro-crystalline wax, and others.

The metal/ceramic particles that make up the green body can have a variety of shapes and sizes. In some examples, the metal/ceramic particles can have a particle size from about 1 micrometer to about 100 micrometers, or from about 1 micrometer to about 50 micrometers, or from about 1 micrometer to about 20 micrometers, or from about 1 micrometer to about 10 micrometers, or from about 20 micrometers to about 100 micrometers, or from about 50 micrometers to about 100 micrometers. In other examples, the metal/ceramic particles can have a particle size distribution from 2-15 micrometers, 5-15 micrometers, 5-20 micrometers, 5-25 micrometers, 10-25 micrometers, 10-30 micrometers, 10-45 micrometers, 15-45 micrometers, 0-45 micrometers, and 0-30 micrometers, including tolerances of <2%, <5% or <10% of these range endpoints. In certain examples, the metal/ceramic particles can be spherical or nearly spherical, such as having a ratio of the longest dimension to the shortest dimension that is 1.2 or less or 1.1 or less.

In some examples, the hot wall furnaces described herein can be used to debind and sinter granules that are made up of metal/ceramic particles bound together by a binder. Alternatively, the granules can be subjected to solvent debinding which can be useful and effective in some cases to avoid heat requirements of furnace debinding. Non-limiting examples of suitable solvents for debinding can include polyethylene glycol, oxalic acid, heptane, hexane, ammonium hydroxide, ethyl alcohol, methyl methacrylate, butyl acetate, dimethyl carbonate, methanol, ethyl acetate, sec-butyl alcohol, and the like. In some further examples, solvent debinding can optionally be followed by thermal debinding. Regardless, the granules can be useful as a feedstock material for 3D printing and other applications. In certain examples, the granules can be titanium or titanium alloy to be used for 3D printing titanium articles. Several processes that can be used to prepare titanium granules are described below.

In certain examples, the titanium feedstock can be particles prepared using the granulation-sintering-deoxygenation process (GSD), hydrogen-assisted magnesiothermic reduction (HAMR), direct reduction and alloying (DRA), or other processes.

In one example, the titanium raw material can be mixed with at least one alloying element powder. The alloying element powder can include elemental metals, metal oxides, metal hydrides, or combinations thereof. In one case, the at least one alloying element powder is a metal oxide powder. Non-limiting examples of suitable metal oxide powder can include Al₂O₃, V₂O₅, CuO, MnO, V₂O₃, Fe₂O₃, Nb₂O₅, ZrO₂, MoO₃, MoO₂, Cr₂O₃, SnO₂, SiO₂, Ta₂O₅, CoO, WO₃, NiO, and combinations thereof including oxides of elements in the above list with varying valence states. For example, V₂O₃ can allow for better wettability and lower dwell times or temperatures than V₂O₅ during sintering (i.e. homogenization steps).

Alternatively, or in addition, the at least one alloying element powder can include an elemental metal. Non-limiting examples of suitable elemental metals include Al, Mo, V, Nb, Ta, Fe, Cr, Mn, Co, Cu, W, Zr, Sn, Ni, Si, and combinations thereof. In one example, the at least one alloying element powder can include a metal hydride. Non-limiting examples of suitable metal hydrides include aluminum hydride, vanadium hydride, niobium hydride, tantalum hydride, zirconium hydride, silicon hydride, and combinations thereof.

In one example, the alloying element powder can also include a mixture of oxides and elemental powder. Regardless, the choice of alloying element powders can depend on the desired titanium alloy product. Appropriate molar ratios of elemental metals in feed powder can be chosen in order to produce a desired alloy. Non-limiting examples of titanium alloys which can be produced include Ti-6Al-4V, Ti-2.5Cu, Ti-8Mn, Ti-3Al-2.5V, Ti-5Al-2.5Fe, Ti-6Al-7Nb, Ti-13Nb-13Zr, Ti-15Mo-5Zr, Ti-10V-2Fe-3Al, Ti-8V-3Al-6Cr-4Mo-4Zr, Ti-6Al-2 Sn-4Zr-2Mo-0.1 Si, Ti-15Mo-3Al-2.7Nb-0.25 Si, Ti-15Mo-2Sn-4Zr-4Mo-2Cr-1Fe, and the like.

The granules prepared using these processes can have a granule size that is from about 20 micrometers to about 100 micrometers, or from about 50 micrometers to about 100 micrometers, or from about 20 micrometers to about 50 micrometers, in some examples.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology, thus generally described, will be understood more readily by reference to the following examples, which are provided by way of illustration and are not intended to be limiting.

### Examples

Example 1. An example method of making a sintered article using a hot wall furnace as described herein includes the following steps: 1) Load green titanium granules in sheet metal trays, covering with a lid. 2) Place the trays with titanium powder into loading rack. 3) Place assembled batch rack in a preloading station. 4) Place the load onto an empty base station. 5) Gantry crane places retort bell over the load. 6) Retort bell hydraulically latches onto base station and evacuation of retort bell begins. 7) Gantry crane places furnace bell over the retort bell and evacuation of the furnace bell begins. 8) Start thermal cycle of heating to sintering temperature and holding at sintering temperature. 9) Cool to temperature low enough to remove the furnace bell, such as about 600° C. 10) Stop thermal cycle. 11) Gantry crane lifts furnace bell and moves cooling shroud over the retort bell. 12) Forced cooling of retort bell to 50° C. 13) Gantry crane moves cooling shroud to park station. 14) Backfill retort bell with air and unlatch from base station. 15) Gantry crane removes retort bell. 16) Load is moved off the base station to the unload station. 17) Repeat the process with another load.

### Example Clauses

Clause 1. The present disclosure describes hot wall bell-type furnaces and methods of treating metal/ceramic articles using the furnaces. In one example, a method of treating a metal/ceramic article includes placing a metal/ceramic article in a retort bell. A furnace bell is then placed over the retort bell. A retort pressure in the retort bell can be reduced to a first vacuum pressure, and a support pressure in a plenum space between the retort bell and the furnace bell can be reduced to a second vacuum pressure. The metal/ceramic article can be heated to a treatment temperature (e.g. sintering temperature, hydriding temperature, dehydriding temperature, deoxygenation temperature, heat treatment temperature, etc). The treatment temperature can be maintained along with the first vacuum pressure and second vacuum pressure for a treatment time to form a treated metal/ceramic article. The metal/ceramic article can be a green body, a sintered metal article to be treated, or a cast metal article to be treated (e.g. via hydrogen heat treatment, debinding, hydriding, dehydriding, deoxygenation, or the like).

Clause 2. The method of any clause, wherein the first vacuum pressure can be within 10% of the second vacuum pressure, a pressure differential between the first vacuum pressure and the second vacuum pressure can be 100 millibar or less, a pressure differential is less than 50 millibar less than 10 millibar, less than 1 millibar, less than 10⁻² millibar, or less than 10⁻⁴ millibar. The first vacuum pressure and the second vacuum pressure can be from about 10⁻⁶ millibar to 500 millibar, and in some cases up to 900 millibar. In further examples, the sintering temperature can be from about 600° C. to about 1,450° C., or from about 1,000° C. to about 1,250° C. The treatment time can generally be from about 1 minute to about 5 hours. During the treatment time, the retort bell can have a temperature variation of less than 100° C. between a coldest location inside the retort bell and a hottest location inside the retort bell during the treatment time, and in some cases less than 50° C. variation, and in other cases less than 20° C. variation.

Clause 3. The method of any clause can also include supplying a noble gas, non-reactive gas, or combination thereof, into the retort bell at a pressure from about 10⁻³ millibar to about 800 millibar. The noble gas or non-reactive gas can also be supplied into the plenum space at a pressure from about 10⁻¹ millibar to about 10⁻³ millibar, and in some cases up to about 800 millibar. In certain examples, the noble or non-reactive gas can include nitrogen, argon, hydrogen, mixtures thereof, and mixtures with other gases.

Clause 4. The method of any clause, wherein the metal/ceramic article is a green body which includes at least one of metal particles and ceramic particles bound with an organic binder. In this clause the treatment temperature is a sintering temperature of the metal/ceramic article, and the treatment time is a sintering time sufficient to at least partially sinter the green body to form a sintered article. In this clause, the green body can include a plurality of granules made up of the metal/ceramic particles and the organic binder. In this clause, the organic binder can be substantially free of silicon, and can be formed of hydrocarbons.

Clause 5. The method of any clause, wherein the method also includes debinding the green body at a debinding temperature below the sintering temperature.

Clause 6. The method of any clause, wherein the pressure within the retort bell can be reduced by a first vacuum pump connected to the retort bell, and the method can include collecting volatilized organic binder in a cold trap connected between the retort bell and the first vacuum pump.

Clause 7. The method of any clause, wherein the heating and the maintaining are performed under a hydrogen atmosphere to form the sintered article, and the method further comprises maintaining the sintered article at a phase transformation temperature for a transformation time sufficient to adjust grain sizes of metallurgical phases within the sintered article.

Clause 8. The method of any clause, wherein the metal/ceramic article is a sintered article, wherein the heating and the maintaining are at least one of hydriding, dehydriding, phase transformation, and deoxygenation.

Clause 9. The method of any clause, wherein the pressure in the plenum space can be reduced by a second vacuum pump connected to the plenum space.

Clause 10. The method of any clause, wherein the retort bell and the furnace bell can include bottom openings and the bottom openings can be sealed onto a base during the sintering time to form a sealed retort space and a sealed plenum space. The retort bell, the furnace bell, or both, can be lowered onto the base by a gantry.

Clause 11. The method of any clause can also include cooling the retort bell after the treatment time.

Clause 12. The method of any clause, wherein the cooling can be accomplished by replacing the furnace bell with a cooling shroud.

Clause 13. The method of any clause, wherein the retort bell can be cooled to a final temperature from about 20° C. to about 100° C.

Clause 14. The method of any clause, wherein the method also includes lifting the retort bell after the cooling to retrieve the sintered article.

Clause 15. The method of any clause, wherein the furnace bell can include an outer shell and a heating element positioned inwardly towards the retort bell when the furnace bell is placed over the retort bell.

Clause 16. The method of any clause, wherein the furnace bell can also include an insulation layer between the heating element and the outer shell.

Clause 17. The method of any clause, wherein the retort bell and the furnace bell have a vertical cylindrical shape.

Clause 18. The method of any clause, wherein the retort bell includes high temperature stainless steel, silicon carbide, carbon fiber, Inconel, carbon composites, graphite, composites thereof, alloys thereof, or combinations thereof.

Clause 19. The method of any clause, wherein the furnace bell includes carbon steel, high temperature stainless steel, silicon carbide, carbon fiber, Inconel, carbon composites, graphite, composites thereof, alloys thereof, or a combination thereof.

Clause 20. The method of any clause, wherein the retort bell and the furnace bell are devoid of at least one of molybdenum and tungsten.

Clause 21. Hot wall furnaces which includes a base station including a green body support and a vacuum source, a retort bell which is sealable onto the base station over the green body support to form a retort space, where the retort bell can be adapted to a treatment temperature above 1,000° C., and a furnace bell which is sealable onto the base station over the retort bell such that the retort bell is contained within a volume between the base station and the furnace bell to form a plenum space, where the vacuum source is adapted to maintain a vacuum pressure in the retort space and in the plenum space.

Clause 22. The hot wall furnaces of any clause, wherein the vacuum source can include a first vacuum pump and a second vacuum pump, where the first vacuum pump is connected to the retort space inside the retort bell and where the second vacuum pump is connected to the plenum space between the retort bell and the furnace bell.

Clause 23. The hot wall furnaces of any clause, wherein the base station can also include a cold trap connected between the retort space inside the retort bell and the first vacuum pump.

Clause 24. The hot wall furnaces of any clause, further including a cooling system connected to the cold trap to cool the cold trap.

Clause 25. The hot wall furnaces of any clause, wherein the retort bell can be adapted to a sintering temperature above about 1,200° C., or above about 1,250° C.

Clause 26. The hot wall furnaces of any clause, wherein the base station can also include a noble gas source or a non-reactive gas source connected to the retort space inside the retort bell.

Clause 27. The hot wall furnaces of any clause, wherein the retort bell and the furnace bell include bottom openings and the bottom openings can be sealable onto the base station.

Clause 28. The hot wall furnaces of any clause, wherein also includes a gantry adapted to lift the furnace bell, the retort bell, or both off of the base station.

Clause 29. The hot wall furnaces of any clause, wherein the hot wall furnace also includes a cooling shroud adapted to be placed over the retort bell by the gantry after the furnace bell has been removed.

Clause 30. The hot wall furnaces of any clause, wherein the furnace bell can include an outer shell and a heating element positioned inwardly towards the retort bell when the furnace bell is placed over the retort bell.

Clause 31. The hot wall furnaces of any clause, wherein the furnace bell also includes an insulation layer between the heating element and the outer shell.

Clause 32. The hot wall furnaces of any clause, wherein the base station also includes a power connector connectable to the heating element to supply electric power to the heating element.

Clause 33. The hot wall furnaces of any clause, wherein the retort bell and the furnace bell have a vertical cylindrical shape.

Clause 34. The hot wall furnaces of any clause, wherein the retort bell includes high temperature stainless steel, silicon carbide, carbon fiber, Inconel, quartz, carbon composites, graphite, composites thereof, alloys thereof, or a combination thereof.

Clause 35. The hot wall furnaces of any clause, wherein the furnace bell includes carbon steel, stainless steel, silicon carbide, carbon fiber, Inconel, quartz, carbon composites, graphite, composites thereof, alloys thereof, or a combination thereof.

Clause 36. The hot wall furnaces of any clause, wherein the retort bell and the furnace bell are devoid of at least one of molybdenum and tungsten.

Clause 37. The hot wall furnaces of any clause, wherein the base station can also include a gas outlet beneath the retort bell and baffles are positioned between the green body support and the gas outlet.

Clause 38. The hot wall furnaces of any clause, wherein the base station includes a baffle system oriented between the green body support and the vacuum source and adapted to circulate gases or prevent a straight-line pathway between the cold trap and the green body support, and to function as a heat shield.

What is claimed is:

1. A method of treating a metal/ceramic article, comprising:
placing the metal/ceramic article in a retort bell;
placing a furnace bell over the retort bell;
reducing a retort pressure in the retort bell to a first vacuum pressure;
reducing a support pressure in a plenum space between the retort bell and the furnace bell to a second vacuum pressure;
heating the metal/ceramic article to a treatment temperature; and
maintaining the treatment temperature, first vacuum pressure, and second vacuum pressure for a treatment time to form a treated metal/ceramic article.

2. The method of claim 1, wherein the first vacuum pressure is within 10% of the second vacuum pressure.

3. The method of claim 1, wherein the first vacuum pressure and the second vacuum pressure are from about 10⁻⁶ millibar to 500 millibar.

4. The method of claim 1, wherein the metal/ceramic article is a green body comprising at least one of metal particles and ceramic particles bound with an organic binder, wherein the treatment temperature is a sintering temperature, and wherein the treatment time is a sintering time sufficient to at least partially sinter the green body to form a sintered article.

5. The method of claim 4, wherein the sintering temperature is from about 600° C. to about 1,250° C.

6. The method of claim 4, wherein the organic binder is substantially free of silicon.

7. The method of claim 4, further comprising debinding the green body at a debinding temperature below the sintering temperature.

8. The method of claim 7, wherein the pressure within the retort bell is reduced by a first vacuum pump connected to the retort bell, and wherein the method further comprises collecting volatilized organic binder in a cold trap connected between the retort bell and the first vacuum pump.

9. The method of claim 1, wherein the metal article is at least one of a sintered article and a cast article, wherein the heating and the maintaining are at least one of hydriding, dehydriding, phase transformation, and deoxygenation.

10. The method of claim 1, wherein the retort bell has a temperature variation of less than 20° C. between a coldest location inside the retort bell and a hottest location inside the retort bell during the sintering time.

11. The method of claim 1, further comprising supplying a noble gas, a non-reactive gas, or a combination thereof, into at least one of the retort bell and the plenum space at a pressure from about 10⁻¹ millibar to about 10⁻³ millibar.

12. The method of claim 1, wherein the retort bell and the furnace bell comprise bottom openings and wherein the bottom openings are sealed onto a base during the treatment time to form a sealed retort space and a sealed plenum space.

13. The method of claim 1, wherein the furnace bell comprises an outer shell and a heating element positioned inwardly towards the retort bell when the furnace bell is placed over the retort bell.

14. The method of claim 13, wherein the furnace bell further comprises an insulation layer between the heating element and the outer shell.

15. The method of claim 1, wherein the retort bell and the furnace bell have a vertical cylindrical shape.

16. The method of claim 1, wherein the retort bell comprises high temperature stainless steel, silicon carbide, carbon fiber, Inconel, quartz, carbon composites, graphite, composites thereof, alloys thereof, or a combination thereof and the furnace bell comprises carbon steel, quartz, stainless steel, silicon carbide, carbon fiber, Inconel, quartz, carbon composites, graphite, composites thereof, alloys thereof, or a combination thereof.

17. The method of claim 1, wherein the retort bell and the furnace bell are devoid of at least one of molybdenum and tungsten.

18. A hot wall furnace, comprising:
a base station comprising a metal/ceramic article support and vacuum source;
a retort bell which is sealable onto the base station over the metal/ceramic article support to form a retort space, wherein the retort bell is adapted to a treatment temperature above 1,000° C.; and
a furnace bell which is sealable onto the base station over the retort bell such that the retort bell is contained within a volume between the base station and the furnace bell to form a plenum space;
wherein the vacuum source is adapted to maintain a vacuum pressure in the retort space and in the plenum space.

19. The hot wall furnace of claim 18, wherein the vacuum source comprises a first vacuum pump and a second vacuum pump, wherein the first vacuum pump is connected to the retort space inside the retort bell and wherein the second vacuum pump is connected to the plenum space between the retort bell and the furnace bell.

20. The hot wall furnace of claim 18, wherein the base station further comprises a cold trap connected between the retort space inside the retort bell and the first vacuum pump and a cooling system connected to the cold trap to cool the cold trap.

21. The hot wall furnace of claim 18, wherein the retort bell is adapted to a treatment temperature above about 1,200° C.

22. The hot wall furnace of claim 18, wherein the base station further comprises a noble gas source or a non-reactive gas source connected to the space inside the retort bell.

23. The hot wall furnace of claim 18, wherein the retort bell and the furnace bell comprise bottom openings and wherein the bottom openings are sealable onto the base station.

24. The hot wall furnace of claim 18, wherein the furnace bell comprises an outer shell and a heating element positioned inwardly towards the retort bell when the furnace bell is placed over the retort bell.

25. The hot wall furnace of claim 24, wherein the furnace bell further comprises an insulation layer between the heating element and the outer shell.

26. The hot wall furnace of claim 18, wherein the retort bell and the furnace bell have a vertical cylindrical shape.

27. The hot wall furnace of claim 18, wherein the retort bell comprises high temperature stainless steel, silicon carbide, carbon fiber, Inconel, quartz, carbon composites, graphite, composites thereof, alloys thereof, or a combination thereof and the furnace bell comprises carbon steel, quartz, stainless steel, silicon carbide, carbon fiber, Inconel, quartz, carbon composites, graphite, composites thereof, alloys thereof, or a combination thereof.

28. The hot wall furnace of claim 18, wherein the retort bell and the furnace bell are devoid of at least one of molybdenum and tungsten.

29. The hot wall furnace of claim 18, wherein the base station comprises a gas outlet beneath the retort bell and wherein baffles are positioned between the metal/ceramic article support and the gas outlet.

30. The hot wall furnace of claim 18, wherein the base station further comprises a baffle system oriented between the metal/ceramic article support and the vacuum source and adapted to circulate gases or prevent a straight-line pathway between the cold trap and the metal/ceramic article support.
